(19) United States
(12) Patent Application Publication
(10) Pub. No.: US 2007/0195520 A1
(43) Pub. Date: Aug. 23, 2007

(54) Flashlight holder

(76) Inventor: Charles Dwayne O'Brien, Bakersfield, CA (US)

Correspondence Address: Galasso & Associates, LP, P.O. Box 26503, Austin, TX, 78755-0503, US

(21) Appl. No.: 11/357,689

(22) Filed: Feb. 17, 2006

(51) Int. Cl. F21L 4/00

(52) U.S. Cl. 362/191

(57) ABSTRACT

A flashlight holder is disclosed that includes a first interface configured to secure a flashlight, a user interface configured to secure the flashlight holder to a user's arm at least one adjustable member between the flashlight holder and the user interface. An adjustable pivot can be provided as part of the adjustable member such that an angle of the flashlight to the user interface or the users arm can be adjusted to place a beam of light in a desired location in relationship to a user's hand. In one embodiment the flashlight holder can have a second adjustable member wherein one or both of the first and second adjustable member can be adjusted in height to determine the angle of the flashlight in relationship user interface. Fastening members can be utilized to secure the user interface to a user and the flashlight to the flashlight holder. The fasteners bands can utilize hook and loop fasteners, buckles or an over center latch.

### FIELD OF THE DISCLOSURE

The present disclosure is generally related to a flashlight holder and more particularly to flashlight holder that can position a light beam on a subject of interest while leaving users hands free.

### BACKGROUND

Often, one is required to grasp a flashlight and shine the light beam of the flashlight on a particular object during certain procedures. For example, when hand operated tools are required to accomplish a task in the dark it can be nearly impossible to shine the light beam in a desired area while operating the hand tool. When working on a car at night, typically one hand is needed to hold the tool, while the other hand may be required to hold something out of the way or to hold the component being worked on. More importantly, in some professions such as that of a peace officer, the officer may need to use his hands to operate many tools simultaneously in the dark. For example, an office may need to use his radio, while carrying a gun leaving no way to hold a flashlight in a potentially dangerous situation. Additionally, the officer may need to have pepper spray or handcuffs readily available leaving no way to hold the flashlight. Accordingly, there is a need for a way to direct a light beam from a flashlight to a critical location while leaving the hands of a user free to grasp tools and the like.

### BRIEF DESCRIPTION OF THE DRAWINGS

FIG. 1 is a side view of an arm mountable flashlight holder; and

FIG. 2 is front view of the arm mountable flashlight holder.

### DETAILED DESCRIPTION OF THE DRAWINGS

A flashlight holder is disclosed that includes a first interface configured to secure a flashlight, a user interface configured to secure the flashlight holder to a user's arm, at least one adjustable member between the flashlight holder and the user interface. An adjustable pivot can be provided as part of the adjustable member such that an angle of the flashlight to the user interface or to the user's arm can be adjusted to place a beam of light in a desired location in relationship to a user's hand.

In one embodiment, the flashlight holder can have a second adjustable member wherein one or both of the first and second adjustable members can be adjusted in height to determine the angle of the flashlight in relationship to the user interface. The flashlight holder can be a “U” shaped member to cradle the flashlight and the user interface can also be U shaped to secure the holder onto the user's forearm arm. Additionally, the user interface and the flashlight holder can be semi rigid U shaped member such that they can conform to, and squeeze the top of users fore arm and the flashlight when fastened. Fastening members such as fastener bands or straps can be utilized to secure the user interface to a user and the flashlight to the flashlight holder. The fasteners bands can be tightened and then secured utilizing hook and loop fasteners, buckles or an over center latch.

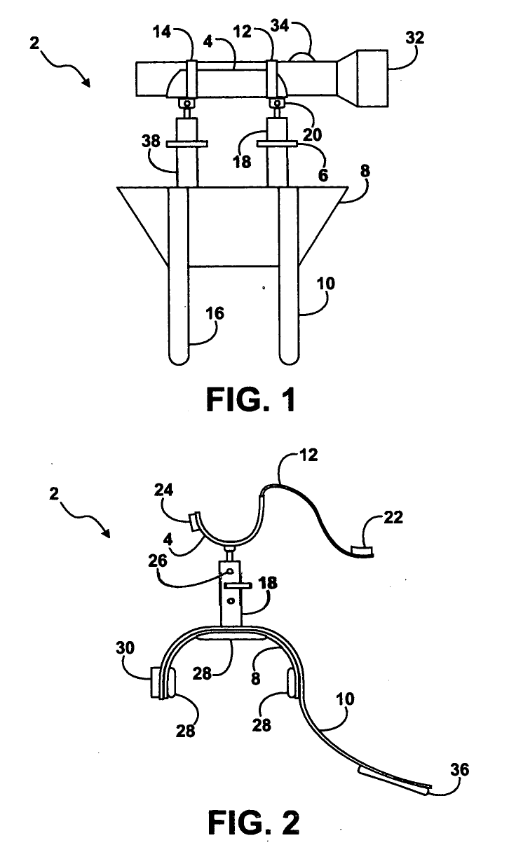

Referring to FIG. 1 an arm mountable flashlight holder (AMFH) 2 is depicted. The AMFH 2 can have a flashlight holder 4 at least one adjustable rigid member 18, and a user interface 8. Fastener bands 12 and 14 can be utilized to secure a light source such as a flashlight 32 to the flashlight holder 4. Fastener bands 10 and 16 can be utilized to secure the AMFH 2 via the user interface 8 to a users arm. When a flashlight 32 is placed on the flashlight holder 4, the fastener bands 12 and 14 can be wrapped over the flashlight 32 and fastened across the top of the flashlight 32 and affixed to the other side of the flashlight holder 4.

Referring briefly to FIG. 2 an end view an AMFH 2 is provided. As is illustrated, fastener band 12 can have loop fasteners 22 to mate with hook fasteners 24. Likewise, fastener band 10 can have a loop fastener 36 to mate with hook fasteners 30. The hook fasteners and loop fasteners can be manufactured as part of the same band or could be separate pieces assembled to the flashlight holder 4 and the user interface 8. Thus, fastener bands 10 and 12 can include a loop and hook fastening mechanism such as Velcro™ that allows an infinite amount of adjustments to the length of the fasteners and thus the AMFH 2 can be adjusted to accommodate most flashlight sizes and the size of the users arm.

Referring back to FIG. 1 hook and loop fasteners can also provide quick installation and release of the AMFH 2 from a user's arm. In another embodiment, the fasteners 10, 12, 14, and 16 could utilize a buckle such as those commonly utilized in wristwatch bands or belts. In other embodiments a stretchy cord with hooks could be utilized to secure flashlight 32 to flashlight holder 4. Additionally, any buckle, pin and hole arrangement or mechanical clasping arrangement such as an over center latch or clip could be utilized to secure the fastener bands 10 and 12 without parting from the scope of the present disclosure.

The flashlight holder 4 could be lined with a gripping material such as a rubber or neoprene pad that can firmly grip the flashlight 32 without scratching the surface of the flashlight 32. As illustrated in the specific embodiment of FIG. 1, flashlight holder 4 and user interface 8 could be concave members to cradle or engage a radius or a curved portion of the flashlight 4 and the users arm. The flashlight holder 4 can be made of thin aluminum or semi rigid plastic such that when the fasteners are tightened, the flashlight holder can “deform” wherein the sides of the flashlight holder can “collapse” on the side of the flashlight 32. Likewise, the user interface 4 can be made of semi rigid plastic and as the fasteners are tightened the user interface 8 could collapse to securely cradle the curvature of the users arm.

Although cradle shaped members that can “surround” a portion of the flashlight 32 and the users arm are illustrated for the flashlight holder 4 and the user interface 8, a rigid straight flat member would not part from the scope of the present disclosure. Also, it can be appreciated that a flashlight having almost any shape can be inserted into and secured by the flashlight cradle 32. Even flashlights with external “sliding” or push button switch 34 can be secured by the flashlight holder 4 wherein the flashlight 32 can be positioned such that switch 34 does not interfere with flashlight holder 4.

Referring to FIG. 2 at least one adjustable rigid member (ARM) 18 can be utilized to attach the flashlight cradle to the user interface 8. ARM 18 can have a telescoping feature that utilizes a pin 6 inserted into holes 26 such as shown in FIG. 2. Thus, the pin 6 can be removed, the ARM 18 can be lengthened or shortened and when the holes are aligned the pin 6 can be re-inserted into the holes 26 to adjust the length of the ARM 18. Adjustable pivot 20 can be utilized to angle the flashlight holder 4 in relation to the users forearm. Adjustable pivot 20 can be implemented with a screw, a nut and a friction material.

When two ARMS 18 and 38 are utilized a pin 6 can be placed in each of the ARMS 18 and 36 to adjust the angle of the flashlight 4 in relation to the user interface 8. This adjustment allows a user to adjust the light beam of the flashlight to an area proximate to the users hand if desired.

ARMs 18 and 38 could also be implemented with a hinge such as a scissors type mechanism or pivoting arms without parting from the scope of the disclosure. The ARMs 18 and 38 can attach to the flashlight holder 4 at the pivot such that the angle of the flashlight holder 4 in relation to the user interface 8 can be adjusted.

Pads 28 can be fastened to the user interface 8 to provide additional gripping or friction on the users arm. For example, it is desirable that during motion of a user's arm that the AMFH 2 does not rotate around the users arm. Thus, the pads 28 can provide comfort and resistance to sliding and rotating of the AMFH 2 about the users arm.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A flashlight holder comprising:
a cradle shaped member configured to secure a flashlight,
a first telescoping member coupled to the cradle shaped member;
a second telescoping member coupled to the cradle shaped member; and
a forearm interface coupled to the first telescoping member and the second telescoping member wherein adjusting a length of the first telescoping and the second telescoping member adjusts an angle of the flashlight in relationship to the forearm interface.

2. The flashlight holder of claim 1 wherein the forearm interface is collapsible on a users forearm.

3. The flashlight holder of claim 1 further comprising a pivot on the first and the second telescoping members.

4. The flashlight holder of claim 1 further comprising fastening members.

5. The flashlight holder of claim 4 wherein the fastening members comprise a hook fastener, a loop fastener, a buckle, and a latch.

6. A flashlight holder comprising:
an adjustable member;
a first interface configured to secure a light source, the first interface coupled to the adjustable member; and
a user interface configured to secure the holder to a users arm wherein the first interface can be moved in relation to the user interface.

7. The holder of claim 6 wherein the adjustable member comprises a pivot.

8. The holder of claim 6 further comprising a second adjustable member.

9. The holder of claim 8 wherein the second adjustable member has a pivot point.

10. The holder of claim 6 wherein the adjustable member is a telescoping member.

11. The holder of claim 6 wherein the first interface is a “U” shaped member.

12. The holder of claim 6 wherein the user interface is a “U” shaped member.

13. The holder of claim 6 further comprising at least one fastening member configured to fasten the light source to the first interface.

14. The holder of claim 13 wherein the at least one fastening member comprises at least one of an over center latch, a buckle, an over center latch and hook and loop fasteners.

15. A flashlight holder comprising:
an arm cradle;
an adjustable member coupled to the arm cradle; and
a flashlight holder coupled to the adjustable member wherein the adjustable member has a pivot and the flashlight holder can be moved to different angles in relation to the arm cradle.

16. The flashlight holder of claim 15 further comprising a fastening member configured to fasten a flashlight to the flashlight holder.

17. The flashlight holder of claim 15 further comprising a fastening member configured to fasten the arm cradle to a users arm.

18. The flashlight holder of claim 15 wherein the fastening member further comprises one of a hook fastener, a loop fastener, a buckle or an over center latch.

19. The flashlight holder of claim 15 wherein the adjustable member is one of a telescoping member and a hinging member.

20. The flashlight holder of claim 15 wherein the user interface engages a curved surface of a users arm when a fastener band is secured.
